(19) United States
(12) Patent Application Publication
(10) Pub. No.: US 2003/0018541 A1
(43) Pub. Date: Jan. 23, 2003

(54) System and method for delivering virtual content associated with physical objects, images and events

(76) Inventor: Steven Paul Nohr, Bothell, WA (US)

Correspondence Address: Steven H. Arterberry, Esq., DORSEY & WHITNEY LLP, Suite 3400, 1420 Fifth Avenue, Seattle, WA, 98101, US

(21) Appl. No.: 10/198,605

(22) Filed: Jul. 17, 2002

Related U.S. Application Data
(60) Provisional application No. 60/305,625, filed on Jul. 17, 2001.

(51) Int. Cl. G06F 17/60

(52) U.S. Cl. 705/26

(57) ABSTRACT

The present invention is directed to a system and method for delivering virtual content associated with physical objects, visual images and events of various kinds. In one embodiment, the invention includes a display having a plurality of objects positioned on the display. The display may include various devices to indicate a selected object positioned on the display, or the selection may be indicated by one or more handheld devices. Selection of one or more objects on the display activates a content delivery device that transfers virtual content associated with the one or more selected objects to a viewing device.

### CROSS-REFERENCE TO RELATED APPLICATION

This application claims priority from U.S. Provisional Application No. 60/305,625, filed Jul. 17, 2001.

### TECHNICAL FIELD

The present invention is directed to the presentation and delivery of virtual content to a consumer. More particularly, the present invention is directed to a system and method for presenting and delivering virtual content associated with physical objects, visual images and events of various kinds.

### BACKGROUND OF THE INVENTION

Various recent advances in wireless technology and in electronics in general have permitted the development of a variety of portable and handheld electronic devices that can connect and communicate wirelessly using radio links. For example, cellular telephones, paging devices and personal digital assistants (PDA's) may be used to wirelessly communicate and exchange audio and/or visual information of various kinds. In particular, PDA's currently exist that may be configured to communicate with a content provider through communications networks such as the Internet, and to receive visual and audio information from the provider. Moreover, currently available PDA's generally include an internal memory capacity to store the received data. In many cases, the internal memory capacity of such devices may be significantly increased through the use of removable memory expansion cards. Further, presently existing wireless local area networks (WLAN's) and wireless personal area networks (WPAN's) allow a user of a wireless device to communicate with similarly configured devices, or other centralized devices in a localized area such as in retail establishments of various kinds, or even in significantly larger areas, such as a public auditorium, a stadium, or other similar venues.

The foregoing technical advances have thus created environments wherein a physical object may have an associated virtual content that may be delivered to a recipient in an integrated transaction. As used herein, the term “virtual content” means audio-visual content in electronic form that may be transferred to and stored in an electronic storage device, and includes content other than the content of a physical object, a visual image, or an event. For example, where the physical object is a book, the virtual content could be an advertisement for other books by the same author. The virtual content may include audio and/or visual content that generally adds significant value to the transaction, and thus comprises a valuable adjunct or component to the commercial or non-commercial goods and/or services delivered to the recipient. In certain transactions, the virtual content may comprise a substantial portion of the goods and/or services delivered, while in other transactions, it may constitute a relatively minor portion of the transaction. For example, the purchaser of a book may receive virtual content with the physical item that provides additional material of value to the purchaser, such as an interview with the author, or still or motion video content that pertains to the subject matter of the book. Alternatively, the entire book and the associated virtual content may be provided in virtual form, so that no tangible item is transferred to the purchaser.

The foregoing advances similarly allow a prospective purchaser of a tangible object to conveniently receive and review the virtual content associated with the tangible item prior to selecting a particular item, preferably by means of various wireless devices, which have integral displays, and are configured to communicate through various communications networks.

Prior art methods and systems are directed towards the delivery of a tangible item in wholly virtual form, and do not generally provide an option to receive the item in physical and/or a virtual form. For example, virtual greeting cards are widely available through various providers on the Internet that permit a sender to generate a personalized greeting card and to send the generated card to a designated recipient's e-mail address. Moreover, various membership organizations or subscriber groups exist that permit the exchange of recorded music or video content in a virtual manner through the Internet. Since the foregoing methods generally permit the delivery of the entire item, such as a greeting card, or recorded music in a virtual form, no option generally exists to receive other virtual content associated with the item, which enhances the value of the transferred item.

Still other prior art methods and systems are directed towards providing information wirelessly during a consumer transaction. For example, one such system is a portable shopping system using a portable data entry terminal that provides video and/or audio information to a consumer by wireless means while the consumer is engaged in the process of product selection. The disclosed system provides only informational content that guides the consumer selection, such as providing pricing information, nutritional data associated with a food item, or other promotional or general interest data. One prior art method discloses a method for associating multimedia-based Internet content with tangible objects, such as printed media. According to the disclosed method, a machine readable code containing link information may be scanned and sent to a portal server across a network. The link information is then coupled with user preference information to select a multimedia informational sequence corresponding to the link information and user preferences provided. The contemplated multimedia informational sequence includes only advertising or transaction information.

The prior art systems and methods address a perceived need to convey content about products, personal buying preferences, or other transactional information to a consumer while some selection process is occurring, such as during a shopping trip, and the content is displayed to the consumer while the selection process is occurring. In such systems, no virtual content is associated with the physical object after the selection process.

Accordingly, there presently exists a need for a system and method for delivering other types of virtual content associated with a tangible item, and for delivering virtual content associated with a visual image or an event.

### SUMMARY OF THE INVENTION

The present invention is directed to a system and method for presenting and delivering virtual content associated with physical objects, visual images and events of various kinds. In one aspect, the invention includes a display having a plurality of objects positioned on the display. The display may include various devices to indicate a selected object positioned on the display, or the selection may be indicated by one or more handheld devices. Selection of one or more objects on the display activates a content delivery device that displays virtual content associated with the one or more selected objects.

### BRIEF DESCRIPTION OF THE DRAWINGS

FIG. 1 is a block diagram of a system for associating virtual content with a physical object according to an embodiment of the invention.

FIG. 2 is a block diagram of a system for associating virtual content with visual images according to another embodiment of the invention.

FIG. 3 is a block diagram of a system 30 for associating virtual content with an event according to still another embodiment of the invention.

### DETAILED DESCRIPTION OF THE INVENTION

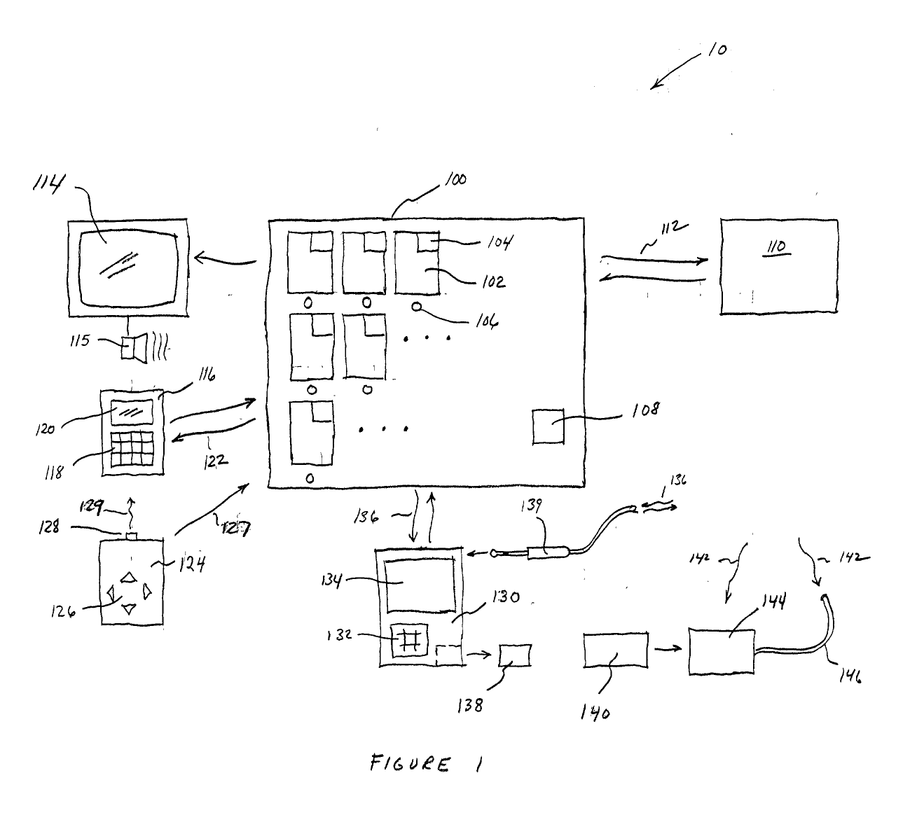

Many of the specific details of certain embodiments of the invention are set forth in the following description and in FIGS. 1 through 3 to provide a thorough understanding of such embodiments. One skilled in the art will understand, however, that the present invention may be practiced without several of the details described in the following description. Moreover, in the description that follows, it is understood that the figures related to the various embodiments are not to be interpreted as conveying any specific or relative physical dimensions, and that specific or relative physical dimensions, if stated, are not to be considered limiting unless the claims expressly state otherwise. Further, illustrations of the various embodiments when presented by way of illustrative examples are intended only to further illustrate certain details of the various embodiments, and shall not be interpreted as limiting the scope of the invention.

FIG. 1 is a block diagram of a system 10 for associating virtual content with a physical object according to an embodiment of the invention. The system 10 includes a display 100 having a plurality of objects 102 positioned on the display 100 for viewing. The display 100 may include shelves, or ledges (not shown in FIG. 1) to support the objects 102 while positioned on the display 100 so that the objects may be physically removed from the display 100. Alternatively, the objects 102 may be fixedly adhered to the display 100 and thus be non-removable from the display 100. When the objects 102 are physically removable, the display 100 may include sensors 104 positioned adjacent to the objects 102 to detect the removal of an object 102 from the display 100. Alternatively, the removal and/or selection of an object 102 positioned on the display 100 may be indicated by manually actuating a touch sensitive device 106 such as a button that is positioned on the display 100, or even a touch sensitive device associated with the object 102. The removal and/or selection of an object 102 from the display 100 may further be detected by a scanner 108 coupled to the display 100 that may be used to detect identifying information associated with the objects 102 when the objects 102 are positioned in proximity to the scanner 108. Accordingly, the scanner 108 may be configured to detect a barcode, or other visual or machine readable identifiers positioned on a portion of the object 102, although other detection methods may also be used. For example, the scanner 108 may be configured to detect radio frequency energy emitted by the object 102, which includes a radio frequency emission device, such as a radio frequency identification (RFID) tag, or other similar device, which is positioned on the object 102. Still further, the scanner 108 may include a device capable of receiving information stored on a magnetic strip positioned on a portion of the object 102. The scanner 108 may also include a camera that is configured to recognize an identifying pattern, design or color present on at least a portion of the object 102.

Still referring to FIG. 1, the system 10 also includes a content delivery device 110 that contains virtual content that is associated with each of the objects 102 positioned on the display 100. The device 110 is configured to exchange signals 112 with the display 100 in order to communicate the virtual content to the display 100. The device 110 may further communicate virtual content to other devices of the system 10, as will be described in greater detail below. The device 110 may further exchange the signals 112 with the display 100 and/or other devices by wireless means, although other methods may be used. For example, the device 110 may be coupled to the display 100 and/or other devices by either a conductive, or a fiber optic cable. Further, the device 110 may be positioned in proximity to the display 100, or even positioned within the display 100, or it may be positioned in a geographical location that is substantially remote from the display 100, so that the signals 112 are exchanged between the content delivery device 110 and the display 100 and/or other devices by means of a communications network (not shown in FIG. 1), such as the Internet, or other telecommunications systems. The content delivery device 110 may further contain various virtual content versions associated with an object 102, so that any one of the versions is selectable.

The system 10 may further include a visual display device 114 coupled to the display 100 that may be used to view the virtual content associated with each of the objects 102 following the transfer of the virtual content to the display 100 and/or other devices. The visual display device 114 may also be coupled to a speaker 115 to produce sound associated with an audio portion of the virtual content. The visual display device 114 may include any type of display known to those skilled in the art, which may include, for example, a cathode ray tube (CRT) display, a liquid crystal display (LCD), or still other suitable display devices.

As previously described, other devices may interact with the display 100 and/or the content delivery device 110 to receive, control, display, or store virtual content provided by the content delivery device 110. For example, and still referring to FIG. 1, a keyboard device 116 having a keypad 118 and a display 120 may exchange signals 122 with the display 100 and/or the content delivery device 110. The keypad 118 may be used to identify a selected object 102 on the display 100 by entering a designated code on the keypad 118 that is associated with the selected object 102. For example, the code may include a predesignated number, or letter associated with each of the objects 102 positioned on the display 100. When the object 102 has been identified, the virtual content associated with the object 102 may be received from the display 100 or the content delivery device 110 and displayed on the display 120 of the device 116. Alternatively, the virtual content may be displayed on the visual display device 114.

A remote control device 124 may also be employed to identify the position of a selected object 102, and to direct the transfer of virtual content associated with the selected object 102. The position of an object 102 on the display 100 may be indicated by manually manipulating directional controls 126 positioned on the remote control device 124 until the position of the desired object 102 is indicated by the visual display device 114, or by other means. For example, the controls 126 may include a set of touch-sensitive pointers that are configured to permit the selection of an object 102, although a keypad (not shown) that permits the manual entry of a code associated with an object 102 may also be used. A signal 127 may then be communicated to the display 100 and/or the content delivery device 110 to indicate the object 102 selected. The virtual content associated with the selection may then be displayed on the display device 114. Alternatively, the remote control device 124 may include a electromagnetic energy emission device 128 that is configured to emit a directed beam 129 of electromagnetic energy at a selected one of the sensors 104 on the display 100 to identify a selected object 102. Accordingly, the entry of a code associated with the selected object 102 may not be required, since the selected object 102 may be identified by directing the beam 130 at the selected object 102. The emission device 128 may include various light emitting devices, or radio frequency emitting devices known to those skilled in the art. In a particular embodiment, the system 10 includes a remote control device 124 configured to emit radio frequency energy, and the object 102 includes an RFID tag. The object 102 is thus identified by directing the radio frequency energy at the RFID tag positioned on the object 102.

The system 10 may further include a hardware device 130 to select one of the objects 102 and to view and direct the transfer of virtual content associated with the selected object 102. The hardware device 130 may include a keypad 132 or other touch-sensitive devices that permit a selected object 102 to be identified. A display 134 may also be included in the device 130 to display the virtual content associated with the selected object 102. The device 130 may further include a removable memory medium 138 that is configured to store the virtual content associated with the selected object 102. The device 130 may further be configured to exchange wireless signals 136 with the display 100 and/or the content delivery device 110. Alternatively, the device 130 may exchange signals with the display 100 and/or the content delivery device 110 through a conductive or optical fiber cable 139 that is received by the device 130. Although FIG. 1 illustrates a dedicated hardware device 130, it is understood that various other well known devices having a variety of form factors may be also be used for the device 130. For example, the device 130 may be a personal digital assistant (PDA) that operates within a closed net environment such as a WLAN or a WPLAN. Alternatively, the device 130 may be a laptop computer with an appropriate network card installed. Further, the device 130 may be a cellphone having a dedicated display surface and having an internally positionable and/or removable memory medium.

With reference still to FIG. 1, the system 10 may also include a memory device 140 that may be received by a memory programming device 144. The memory programming device 144 is configured to receive signals 142 from the content delivery device 100 and/or the display 100 and transfer selected virtual content to the memory device 140 responsive. The signals 142 may be communicated to the memory programming device 144 by wireless means, or alternatively, the signals 142 may be communicated to the programming device 144 by a conductive or fiber optic cable 146.

The operation of the system 10 will now be described in detail. In the description that follows, specific examples of the foregoing embodiment may be used. It is understood, however, that the specific examples cited do not limit the scope of the invention, and are offered merely to help one skilled in the art to better understand the foregoing embodiment. Referring again to FIG. 1, the objects 102 may comprise any physical object commonly displayed on a display rack or shelf. For example, the objects 102 may be books or magazines displayed in a bookstore or newsstand, respectively, or they may be compact disks (CD's), video tapes, greeting cards or other similar items displayed by a retailer. The objects 102 positioned on the display 100 may be viewed by an individual, who selects one or more of the objects 102 by physically removing the object 102 from the display 100, or otherwise indicating a selection by any of the means described above. For example, the individual may actuate the touch sensitive device 106 when the object 102 is removed, thus indicating that a selection has been made. Alternatively, the sensor 104 may indicate that an object 102 has been removed to indicate the selection. In either case, the physical selection of an object 102 triggers the transfer of the virtual content associated with the object 102 from the content delivery device 110. The virtual content may then be viewed on the display device 114, or on any of the previously described devices containing an integral viewing surface, such as the keyboard device 116 or the hardware device 130. For example, if the object 102 is a greeting card, the virtual content may include the subject matter of the card in an animated form, which may also include sound. As a further example, if the object 102 is a CD, the virtual content transferred from the content delivery device 110 may include musical selections from the CD, or other content associated with the CD, such as portions of a music video. The individual may continue to select other objects 102 from the display 100 and review the virtual content associated with each of the objects 102 as they are selected. In one particular embodiment, the transfer of the virtual content associated with any of the selected objects 102 is discontinued when the object 102 is placed in its former position in the display 100. In another particular embodiment, the transfer of the virtual content may be discontinued by actuating the keyboard positioned on the devices 116 and 130. In still another particular embodiment, the content delivery device 110, or another associated device maintains a record of the objects 102 selected, for determining the popularity of a particular object 102, particularly when compared with sales records, or for still other record keeping purposes. In yet still another particular embodiment, the speaker 115 includes a microphone to detect sounds directed towards the display 100, and the system 10 includes a voice recognition apparatus that permits an object 102 to be identified in response to verbal commands, or other sounds.

Following a review of the objects 102 and the associated virtual content, one or more of the objects 102 may be identified for purchase. Since the virtual content constitutes an adjunct to the object 102 that adds value to the object 102, the virtual content may be viewed and not copied prior to purchasing the object 102, or otherwise obtaining authorization to possess the object 102 For example, if the object 102 is a CD that is offered for sale by a retailer, the virtual material, which may include musical selections from the CD, or other related material, may be sampled prior to the purchase, but may not be copied to the removable memory medium 138 or the memory device 140 until a purchase is made.

At the time of purchase, the virtual content is transferred to the removable memory medium 138 or the memory device 140 so that the virtual content comes into possession of the purchaser at the point of sale, if the transaction is of a commercial nature. If the transaction is non-commercial, the virtual content is transferred to an individual when the individual is authorized to receive the virtual content. If the virtual content is transferred to the removable memory medium 138, a possessor may transfer the virtual content to other devices. For example, if the virtual content is associated with a greeting card purchase, an individual may mail the greeting card to the intended recipient, and send the virtual content to the intended recipient by electronic mail or by enclosing the memory device 140 or memory medium 138 along with the physical greeting card, or providing the recipient with a means to retrieve the related virtual content at a later time. Alternatively, the object 102 and the associated virtual content may both be transferred to the removable memory medium 138 or the memory device 140 at the point of sale. For example, where the object 102 is a CD, and the virtual content is a music video, the recorded music from the CD and the virtual content may both be transferred to the removable memory medium 138 or the memory device 140 so that the tangible object 102 remains with the vendor. When the virtual content is transferred to the memory device 140 at a point of sale, the contents of the memory device 140 may be accessed by a compatible device reader (not shown), which may be located within various retail establishments, or other publically available locations, to permits the virtual content stored on the device 140 to be viewed.

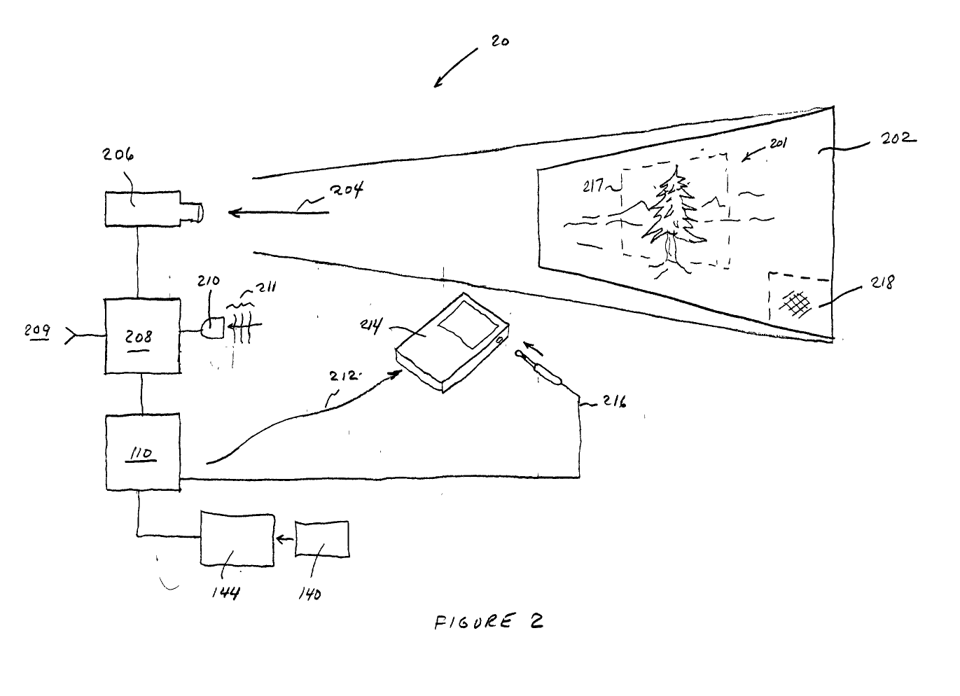

FIG. 2 is a block diagram of a system 20 for associating virtual content with visual images according to another embodiment of the invention. The visual images 201 may include any pre-programmed visual presentation, which may include, for example, a motion picture that is projected onto a reflective display screen 202 by a projection apparatus (not shown), or other similar means for delivering visual images 201 to a viewer. The system 20 includes an optical detector 206 that is configured to detect a reflected portion 204 of the image 201. The reflected portion 204 includes an optical cue 217 that is detected by the optical detector 206, which may include the detection of a discrete portion of a moving image reflected from the screen 202 as shown in FIG. 2. Alternatively it may include the detection of a predetermined optical cue 218 that appears in a selected portion of the screen 202, although other methods of optical cueing may also be used. The optical detector 206 is coupled to the content delivery device 110 (FIG. 1) through a controller 208. The controller 208 receives a signal corresponding to the detected optical cue 217 and communicates with the content delivery device 110 to transfer virtual content associated with a detected cue 217 to a hardware device 214. The hardware device 214 may receive the virtual content by means of wireless signals 212, or through a conductive or optical fiber cable 216. The hardware device 214 may include a dedicated device that is configured to receive signals from the content delivery device 110, or it may include other devices such as a laptop computer having a network card, a PDA, or a cellphone having a memory capability. Although FIG. 2 shows an image 201 that is projected onto the reflective display screen 202, one skilled in the art will readily understand that the screen 202 may be replaced by a screen that is self-luminous, such as a CRT display, or an LED display that is back lighted.

Still referring to FIG. 2, the controller 208 may include a microphone 210 that is configured to receive an acoustic cue 211 that is included in an audio portion associated with the image 201. For example, the cue 211 may be a particular acoustic pattern in an audio portion of a motion picture, or it may include one or more audible or subaudible tones present in the audio portion, although other acoustic cueing methods may also be used. Still further, the controller 208 may be coupled to the projection apparatus (not shown) at an input 209 to receive cues from the projection apparatus, or from other sources. For example, if the projection apparatus includes a conventional film projector, the cues may be received by the controller 208 from a magnetic recording strip affixed to the film so that the cues are successively received by the controller 208 as the projector reads the strip. Alternatively, the input 209 may be coupled to a clock that monitors an elapsed time that is measured from the beginning of the motion picture. The clock may communicate a signal to the controller 208 at predetermined times that, in turn, signal the content delivery device 110 to communicate the virtual content associated with the predetermined time to the hardware device 214. Alternatively, the clock, or other similar device coupled to the controller 208 may be used to signal the content delivery device 110 to transfer all of the virtual content associated with the visual images 201 at a predetermined time. Although the controller 208 is depicted as a separate component in FIG. 2, one skilled in the art will understand that the controller 208 and the content delivery device 110 may be combined into a single functional unit. Still referring to FIG. 2, the content delivery device 110 may further couple to a memory programming device 144 that is configured to receive a memory device 140, such as a “smartcard”, memory card, stored value device, PC card or other similar devices containing a memory for distribution to persons that view the images 201. For example, if the persons attend a film presentation at a theater, the memory device 140 may be distributed to the persons at the conclusion of the performance. The memory device 140 may then be read by a suitable device (not shown) to view the virtual content stored therein.

The operation of the system 20 will now be described in detail. In the description that follows, specific examples of the foregoing embodiment may be used. As before, it is understood that the specific examples cited do not limit the scope of the invention, and are intended to help one skilled in the are to better understand the foregoing embodiment. With reference once again to FIG. 2, when an optical cue 217, an acoustic cue 211 or other signals are received by the system 20, virtual content is communicated to the hardware device 214 by wireless means, or through a cable 216. The virtual content may include any material related to the subject matter in the visual images 201. Upon receiving the virtual content, the recipient may view the virtual content as it is received, or the recipient may defer reviewing the virtual content by storing the virtual content in memory and reviewing it later. In one particular embodiment, the optical cue 217 or acoustic cue 211 may be correlated with the appearance of a branded commercial product in the visual images 201, so that the virtual content that is communicated to the hardware device 214 entails further information about the branded commercial product. In another particular embodiment, the virtual content may include still or motion video segments extracted from a commercial film release, or portions of the film score or soundtrack, or both. Since the virtual content is provided only to motion picture customers that have paid to view the movie, using the system the virtual content may have value as a collectable item that may be traded or sold to other film enthusiasts. Moreover, the system 20 allows the provided virtual content to be frequently changed, which may further increase the collectable value of certain visual content.

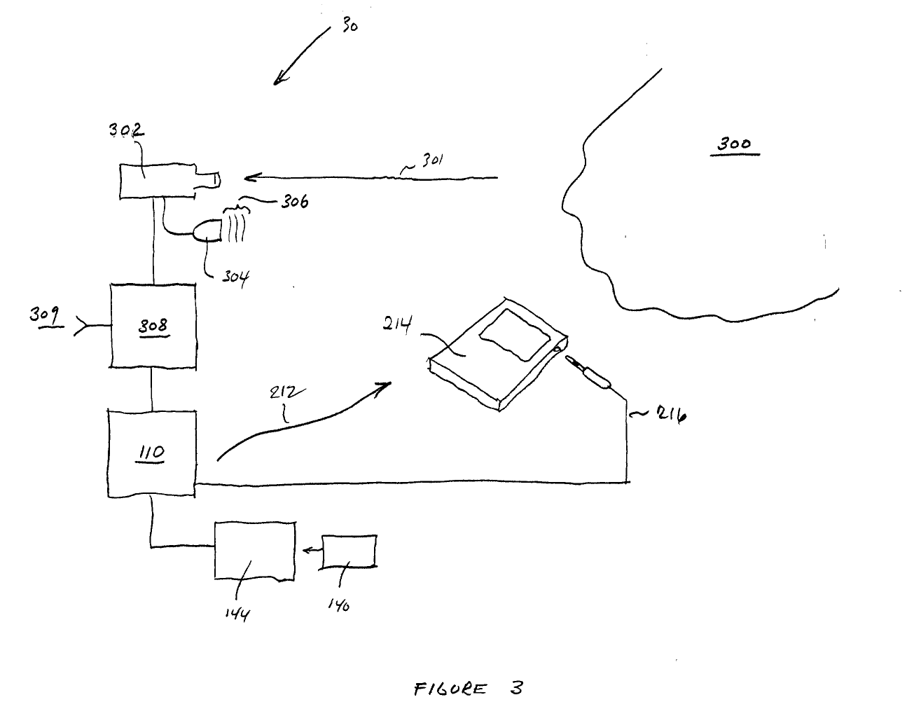

FIG. 3 is a block diagram of a system 30 for associating virtual content with an event according to still another embodiment of the invention. An event 300 includes any pre-planned public or private event that includes live participation where occurrences or actions in the event 300 are not necessarily known at the outset of the event 300. For example, the event 300 may be a sporting event, a live concert, a live stage performance, a public lecture, or other similar events. The system 30 further includes a visual detector 302, which is configured to record images 301 corresponding to various occurrences during the event 300. The visual detector 302 may include any known device for recording images, so that the images 301 may be still images, or moving images. Additionally, a microphone 304 may be coupled to the visual detector 302 to simultaneously detect audio sounds 306 associated with the images 301. The visual detector 302 is coupled to a controller 308 that compiles the recorded images 301 and audio sounds 306 and transfers the compiled information to the content delivery device 110 (FIG. 1) upon receiving an appropriate signal at an input 309. The content delivery device 110 may then communicate the virtual content, which includes the recorded images 301 and/or audio sounds 306 to a hardware device 214. Although the controller 308 is depicted as a separate component in FIG. 3, one skilled in the art will understand that the controller 308 and the content delivery device 110 may be combined into a single functional unit.

The content delivery device 110 may further combine other pre-prepared virtual content with the contemporaneously recorded images 301 and audio sounds 306 prior to communicating the virtual material to the hardware device 214. The hardware device 214 (FIG. 2) may receive the virtual content by means of wireless signals 212, or through a conductive or optical fiber cable 216. The content delivery device 110 may further couple to a memory programming device 144 that is configured to receive a memory device 140, such as a “smartcard”, or other similar devices containing a memory.

Referring still to FIG. 3, the operation of the system 30 will now be described in detail. It is understood, however, that in the description that follows, any specific examples of the foregoing embodiment are not intended to limit the scope of the invention. As before, it is understood that specific examples, when cited, do not limit the scope of the invention, and are intended only to help one skilled in the art to better understand the embodiment. When an appropriate signal is transferred to the controller 308 through the input 309, the content delivery device 110 transfers the virtual content to the hardware device 214 by wireless signals 212, or through a cable 216. The signal applied at the input 309 may be related to a perceived act or occurrence in the event 300. Accordingly, the signal applied to the input 309 may be initiated by a human observer, or by other means. For example, the signal triggering the transfer of virtual content may occur when a specified milestone occurs and is directly observed at a sporting event. Alternatively, the virtual content may be transferred when a predetermined score, or other discrete factor is achieved at the event. In either case, pre-prepared virtual content may be combined with specific occurrences in the event to create unique and intrinsically valuable memorabilia such as virtual sportscards. Only patrons of the particular event having hardware device 214 will receive the virtual content associated with the event, which will limit the numbers of copies of the virtual content and may thereby increase collectable values of the content. For example, where the event is a baseball game and the virtual content is a virtual baseball card associated with some milestone event of a particular player, the limited supply of such virtual card may increase the value of each card. Alternatively, patrons may receive a ticket that includes an RFID tag that may be later read by a station having a content delivery device in order to collect the virtual content on other media device, such as a PDA, cellphone, laptop computer or other devices.

The above description of illustrated embodiments of the invention is not intended to be exhaustive or to limit the invention to the precise form disclosed. While specific embodiments of, and examples of, the invention are described in the foregoing for illustrative purposes, various equivalent modifications are possible within the scope of the invention as those skilled within the relevant art will recognize. Moreover, the various embodiments described above can be combined to provide further embodiments. Accordingly, the invention is not limited by the disclosure, but instead the scope of the invention is to be determined entirely by the following claims.

1. A system for delivering virtual content associated with an object, comprising:
a display having at least one object positioned thereon;
a selection device configured to select the at least one object;
a content delivery device configured to store virtual content associated with the one or more objects that transfers the virtual content to device having a memory when the at least one object is selected.
